(19) United States
(12) Patent Application Publication
(10) Pub. No.: US 2026/0274461 A1
(43) Pub. Date: Sep. 17, 2026

(54) METHOD FOR CONTROLLING ELECTRIC FLIGHT VEHICLE

(71) Applicant: MITSUBISHI HEAVY INDUSTRIES, LTD., Tokyo (JP)

(72) Inventors: Yuki MORISAKI, Tokyo (JP); Suguru HASE, Tokyo (JP); Satoshi YAMASHITA, Tokyo (JP); Yoshihiro KUWAMURA, Tokyo (JP); Yuichi NAKATANI, Tokyo (JP); Yuki ODA, Tokyo (JP)

(73) Assignee: MITSUBISHI HEAVY INDUSTRIES, LTD., Tokyo (JP)

(21) Appl. No.: 19/469,247

(22) PCT Filed: Sep. 21, 2023
(86) PCT No.: PCT/JP2023/034307

§ 371 Date: Sep. 25, 2025

(30) Foreign Application Priority Data
Mar. 30, 2023 (JP) 2023-054553

(51) Int. Cl. B64U 30/29; B64C 27/08; B64C 27/82; B64D 27/34; B64U 10/16; B64U 50/18; B64U 50/19

(52) U.S. Cl. CPC B64U 30/29; B64C 27/08; B64C 27/82; B64D 27/34; B64U 10/16; B64U 50/18; B64U 50/19; B64C 2027/8227; B64C 2027/8245

(57) ABSTRACT

Provided is a method for controlling an electric flight vehicle that comprises: an airframe; a central propulsor disposed in a region including the position of the center of gravity of the airframe; a manifold connected to an outlet of the central propulsor and splitting an airflow into a plurality of directions; a thrust vectoring unit for thrust-vectoring the airflow at outlets of the manifold; a thrust vectoring actuator unit for controlling the attitude of the thrust vectoring unit; and a plurality of peripheral propulsors provided to the airframe so as to surround the central propulsor from the outer peripheral side. The method for controlling the electric flight vehicle includes: a step for starting the central propulsor until reaching a rated rotational speed; and a step for causing the airframe to take off by driving the plurality of peripheral propulsors after the central propulsor has reached the rated rotational speed.

### DESCRIPTION

### Technical Field

The present disclosure relates to a method for controlling an electric flight vehicle.

This application claims the right of priority based on Japanese Patent Application No. 2023-054553 filed with the Japan Patent Office on Mar. 30, 2023, the content of which is incorporated herein by reference.

### Background Art

In recent years, the use of electric flight vehicles typified by drones and multicopters has been expanding (for example, PTL 1 below). An electric flight vehicle mainly includes an airframe and a plurality of propulsors provided in the airframe. The rotation speed of the propulsor can be controlled. When the airframe moves in a horizontal direction, the airframe is tilted by increasing the rotation speed of the propulsor on a side opposite to the direction in which the airframe is to move. In this way, a thrust direction is changed, and the airframe can move in a desired direction.

### CITATION LIST

### Patent Literature

[PTL 1] PCT Japanese Translation Patent Publication No. 2018-529571

### SUMMARY OF INVENTION

### Technical Problem

However, in a case where the posture of the airframe is controlled only by controlling the rotation speed as described above, it takes time to tilt the airframe, and there is a possibility that the posture may be disrupted due to an external force such as a gust of wind during that time. In particular, when the posture of the airframe becomes unstable at the time of take-off and landing, there is a concern that the airframe may come into contact with the ground, which may hinder the stable operation of the electric flight vehicle.

The present disclosure provides an electric flight vehicle capable of taking off and landing without disrupting the posture of an airframe.

### Solution to Problem

A method for controlling an electric flight vehicle according to the present disclosure is a method for controlling an electric flight vehicle that includes an airframe, a central propulsor that is disposed in a region including a gravity center position of the airframe in a plan view and that has an electric motor, a fan which is rotationally driven by the electric motor, and a tubular duct which covers the fan from an outer periphery side, a manifold that is connected to an outlet of the central propulsor and that extends in a plurality of different directions to divert an airflow in the plurality of directions, a thrust vectoring unit that is provided at each outlet of the manifold and that thrust-vectors the airflow, a thrust vectoring actuator unit that controls an angle of the thrust vectoring unit, and a plurality of peripheral propulsors that are provided in the airframe to surround the central propulsor from an outer periphery side in a plan view, and each of which has an electric motor, a fan that is rotationally driven by the electric motor, and a tubular duct that covers the fan from the outer periphery side, the method comprising: a step of starting the central propulsor until a rated rotation speed is reached; and a step of causing the airframe to take off by driving the plurality of peripheral propulsors after the central propulsor has reached the rated rotation speed.

A method for controlling an electric flight vehicle according to the present disclosure is a method for controlling an electric flight vehicle that includes an airframe, a plurality of peripheral propulsors that are provided in the airframe to surround a gravity center position of the airframe from an outer periphery side in a plan view, and each of which has an electric motor, a fan that is rotationally driven by the electric motor, and a tubular duct that covers the fan from the outer periphery side, and a duct thrust vectoring unit that is provided in a part of the plurality of peripheral propulsors to thrust-vector an airflow from the duct, the method comprising: a step of starting the peripheral propulsor having the duct thrust vectoring unit until a rated rotation speed is reached; and a step of causing the airframe to take off by driving remaining peripheral propulsors after the peripheral propulsor having the duct thrust vectoring unit has reached the rated rotation speed;

### Advantageous Effects of Invention

According to the present disclosure, it is possible to provide an electric flight vehicle capable of moving without disrupting the posture of an airframe.

### BRIEF DESCRIPTION OF DRAWINGS

FIG. 1 is a plan view showing a configuration of an electric flight vehicle according to a first embodiment of the present disclosure.

FIG. 2 is a side view showing the configuration of the electric flight vehicle according to the first embodiment of the present disclosure.

FIG. 3 is a functional block diagram showing a configuration of a control unit according to the embodiment of the present disclosure.

FIG. 4 is a flowchart showing a control flow when the control unit according to the embodiment of the present disclosure causes an airframe to move horizontally.

FIG. 5 is an explanatory diagram showing an operation of a thrust vectoring unit and a thrust direction when the airframe moves horizontally, and is a view when the airframe is viewed from above.

FIG. 6 is an explanatory diagram showing a relationship between the operation of the thrust vectoring unit, a flow direction of a fluid, and a magnitude of the momentum of the fluid when the airframe moves horizontally, and is a view when the airframe is viewed from the horizontal direction.

FIG. 7 is an explanatory diagram showing the operation of the thrust vectoring unit and the thrust direction when the airframe is rotated around a yaw axis.

FIG. 8 is a flowchart showing a control flow at the time of take-off/landing of the electric flight vehicle according to the first embodiment of the present disclosure.

FIG. 9 is a plan view showing a configuration of an electric flight vehicle according to a second embodiment of the present disclosure.

FIG. 10 is a flowchart showing a control flow at the time of take-off/landing of the electric flight vehicle according to the second embodiment of the present disclosure.

FIG. 11 is a schematic diagram showing a modification example of the thrust vectoring unit according to the embodiment of the present disclosure.

FIG. 12 is a hardware configuration diagram of the control unit according to each embodiment of the present disclosure.

### DESCRIPTION OF EMBODIMENTS

### First Embodiment

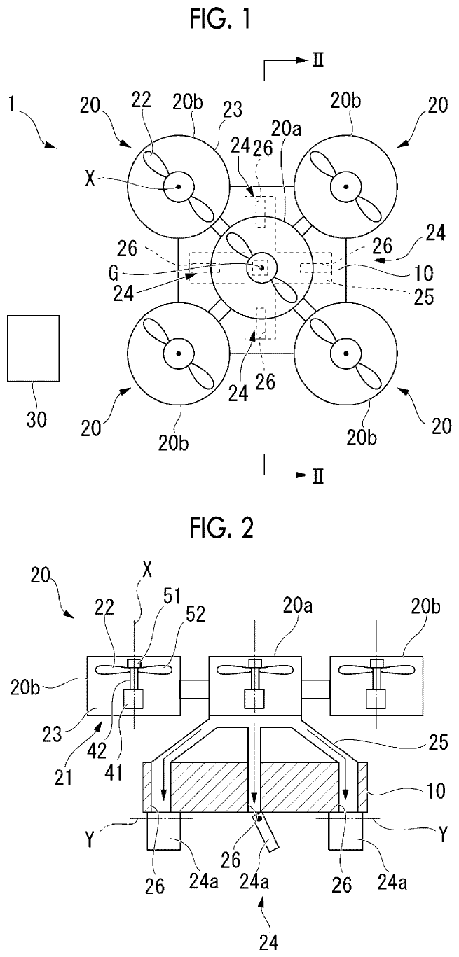

Hereinafter, an electric flight vehicle 1 and a method for controlling the electric flight vehicle 1 according to a first embodiment of the present disclosure will be described with reference to FIGS. 1 to 8. As the use of the electric flight vehicle 1 according to the present embodiment, in addition to the transport of articles between two points, it is assumed that the electric flight vehicle 1 is used for ascending or descending of materials between a low place and a high place.

### (Configuration of Electric Flight Vehicle 1)

As shown in FIG. 1, the electric flight vehicle 1 includes an airframe 10, a central propulsor 20a, a peripheral propulsor 20b, a manifold 25, a thrust vectoring unit 24, a thrust vectoring actuator unit, and a control unit 30. The airframe 10 accommodates various devices such as a battery, a GPS sensor, and a transmission/reception device. Although not shown in detail, the airframe 10 may be formed with a space for loading articles or cargo. In the example of FIG. 1, the airframe 10 has a rectangular shape in a plan view as an example. The central propulsor 20a is provided in a region including a gravity center position G of the airframe 10. One peripheral propulsor 20b is disposed at each of four corners so as to surround the central propulsor 20a from an outer periphery side. That is, a pair of peripheral propulsors 20b is provided on each diagonal line with a geometric gravity center position G of the rectangular airframe 10 interposed therebetween, and a total of four peripheral propulsors 20b are provided.

### (Configurations of Central Propulsor 20a and Peripheral Propulsor 20b)

The central propulsor 20a and the peripheral propulsor 20b have the same configuration except that they are provided at different positions. Therefore, hereinafter, these are collectively referred to as a propulsor 20, and the configuration will be described with reference to FIG. 2. The propulsor 20 is a device for generating thrust when the airframe 10 ascends or descends, moves horizontally, and yaws. The propulsor 20 includes an electric motor 21, a fan 22, and a duct 23.

The electric motor 21 includes an electric motor main body 41 and an output shaft 42. The electric motor main body 41 accommodates a stator and a rotor core. The output shaft 42 is integrally connected to the rotor core. The output shaft 42 extends along the axis X and is rotatable around the axis X. The fan 22 is attached to a shaft end of the output shaft 42. The fan 22 includes a spinner 51 and a blade 52. The spinner 51 has a disk shape centered on the axis X. The spinner 51 may have a pointed shape protruding in the direction of the axis X. The spinner 51 rotates around the axis X in an integrated manner with the output shaft 42.

A plurality of blades 52 extending in a radial direction from an outer peripheral surface of the spinner 51 are provided at intervals in a circumferential direction. In the example of FIGS. 1 and 2, two blades 52 are provided. The number of blades 52 is not limited to two, and may be three or more. The blade 52 has an airfoil-shaped cross-sectional shape when viewed in the radial direction. The blades 52 rotate around the axis X together with the spinner 51, so that a flow of air from one side toward the other side in the direction of the axis X is generated. A reaction force of the momentum of the flow of air serves as thrust for ascending or the like of the airframe 10. In the following description, in a flow direction of an airflow, a side to which the airflow flows away may be referred to as a “downstream side”, and a side opposite to the downstream side may be referred to as an “upstream side”.

The duct 23 has a tubular shape that covers the electric motor 21 and the fan 22 from an outer periphery side. That is, the duct 23 has a tubular shape centered on the axis X. The space inside the duct 23 serves as a flow path through which the airflow generated by the blade 52 passes. The duct 23 is connected to the electric motor main body 41 by a stay. A plurality of the stays extend in the radial direction and are provided at intervals in the circumferential direction. In addition, the electric motor main body 41 may be accommodated in an inner cylinder, and the duct 23 may be supported by bridging a stay between the inner cylinder and the duct 23.

The manifold 25 is connected to an end portion on the downstream side of the central propulsor 20a. The manifold 25 is provided in order to divert the airflow that has passed through the duct 23 of the central propulsor 20a into a plurality of flows. As shown in FIG. 1, four outlet-side openings 26 of the manifold 25 are open on the lower surface of the airframe 10 in a distributed manner. In these four outlet-side openings 26, one outlet-side opening 26 is provided on each side of the airframe 10 having a rectangular shape. Each outlet-side opening 26 has a rectangle in which a direction intersecting each side of the airframe 10 is a long side. The airflow that has passed through the duct 23 branches toward the outlet-side openings 26, and the airflow is dispersed and jetted from each outlet-side opening 26.

The thrust vectoring unit 24 is a device for thrust-vectoring the airflow flowing out from the outlet-side opening 26 of the manifold 25 to change a thrust direction. The thrust vectoring unit 24 is rotatable around a rotation axis Y extending in the radial direction with respect to the axis X of the central propulsor 20a. The thrust vectoring unit 24 is formed of a plate-shaped flap 24a that extends toward the downstream side from the rotation axis Y. As shown in FIG. 1, four thrust vectoring units 24 are provided at intervals of 90°in the circumferential direction. As shown in FIG. 2, a thrust vectoring actuator unit (not shown) is connected to each of the thrust vectoring units 24. The thrust vectoring actuator unit is an actuator that rotates the thrust vectoring unit 24 around the rotation axis Y. The thrust vectoring actuator unit is electrically connected to a control unit 30 (described later), and a drive state thereof is controlled based on an electric signal sent from the control unit 30. Each thrust vectoring unit 24 is configured to be controlled independently.

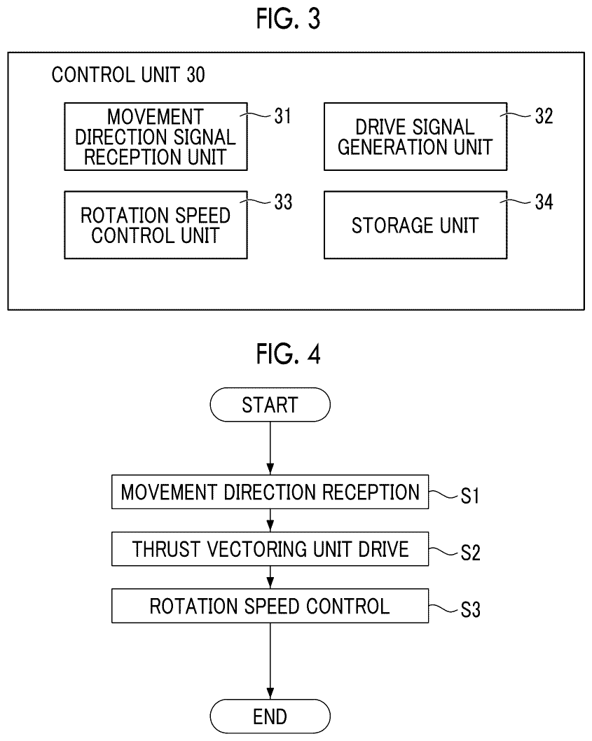

As shown in FIG. 3, the control unit 30 includes a movement direction signal reception unit 31, a drive signal generation unit 32, a rotation speed control unit 33, and a storage unit 34. The movement direction signal reception unit 31 acquires a direction in which the airframe 10 is to be moved, for example, based on a signal input by an operator via remote control. In the following description, the direction in which the airframe 10 moves is simply referred to as a “movement direction D”. The movement direction D is any direction in the horizontal plane.

The drive signal generation unit 32 transmits a signal for driving the thrust vectoring unit 24 to the thrust vectoring actuator unit, based on the movement direction D received by the movement direction signal reception unit 31. That is, which thrust vectoring unit 24 is rotated in which direction and by how much is determined depending on the movement direction D.

The rotation speed control unit 33 controls the rotation speed of each propulsor 20, based on the movement direction D. Details of the operation of the rotation speed control unit 33 will be described later. The storage unit 34 stores various types of information as electric signals. For example, the relationship between the movement direction D, the moving speed, the rotation angle of the thrust vectoring unit 24, and the rotation speed of the propulsor 20, and the like are stored in the storage unit 34 in advance.

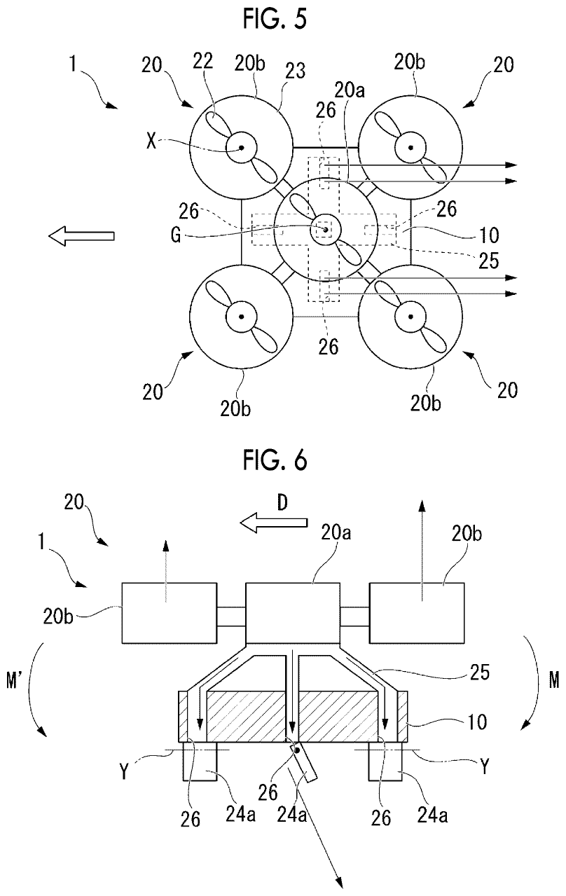

Next, the behavior of each device when the electric flight vehicle 1 moves horizontally in the movement direction D will be described with reference to FIGS. 4 to 6. As shown in FIG. 4, when the movement direction D is input by the operator, in step S1, the movement direction signal reception unit 31 receives information about the movement direction D. Subsequently, in step S2, the thrust vectoring unit 24 is driven in accordance with the movement direction D. Specifically, the drive signal generation unit 32 that has received the signal related to the movement direction D from the movement direction signal reception unit 31 transmits a predetermined electric signal to the thrust vectoring actuator unit. In this way, the thrust vectoring unit 24 rotates by a predetermined angle in a predetermined direction. Then, the direction (thrust direction) of the airflow flowing out from the peripheral propulsor 20b is changed. In this way, thrust as a reaction force of the airflow toward a side opposite to the movement direction D is applied to the airframe 10 (refer to FIG. 5).

At this time, as shown in FIG. 6, when viewed from the horizontal direction orthogonal to the movement direction D, a pitching moment M with the direction as an axis is generated in the airframe 10. Specifically, for example, when the airframe 10 is moved to the left side of the paper surface as shown in FIG. 6, the pitching moment M in a clockwise direction is generated in the airframe 10. When the pitching moment M increases, the airframe 10 is inclined in the clockwise direction. Therefore, the rotation speed control unit 33 generates a counter-moment M′ for canceling the pitching moment M by controlling the rotation speed of the peripheral propulsor 20b (step S3). In a case where the plurality of peripheral propulsors 20b are considered to be divided into the peripheral propulsor 20b located on one side (a moving side: a front side) in the movement direction D and the peripheral propulsor 20b located on the other side (a rear side) with the center of gravity of the airframe 10 interposed therebetween, the rotation speed control unit 33 controls the rotation speed of the peripheral propulsor 20b located on the one side in the movement direction D to be higher than the rotation speed of the peripheral propulsor 20b on the other side. That is, as indicated by the difference in length of arrows in FIG. 6, the thrust by the peripheral propulsor 20b on the one side is larger than the thrust by the peripheral propulsor 20b on the other side. Then, the counter-moment M′ in a counterclockwise direction is generated. In this way, the pitching moment M described above is canceled out. Therefore, the airframe 10 moves toward one side in the movement direction D without tilting, that is, without pitching.

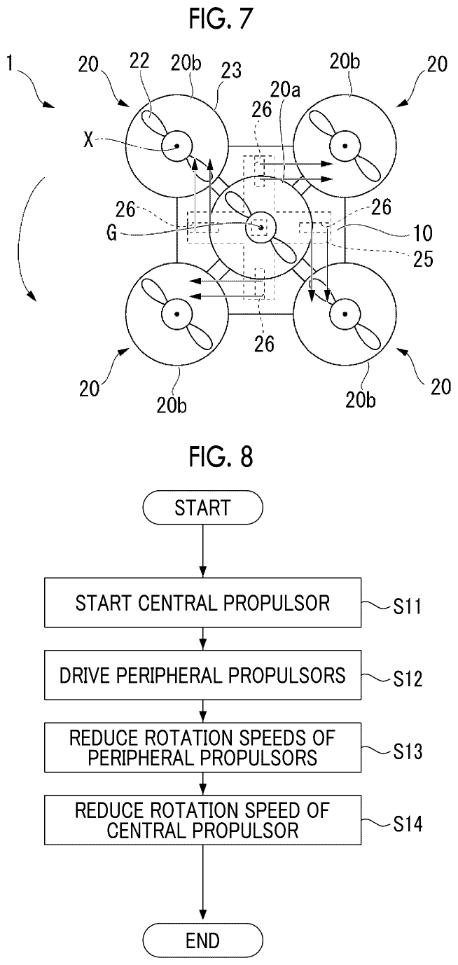

Further, it is also possible to yaw the airframe 10 by operating the thrust vectoring unit 24 in addition to the horizontal movement in the movement direction D. Yawing refers to an operation of rotating the airframe 10 around a yaw axis passing through the center of gravity of the airframe 10. As shown in FIG. 7, when yawing is performed, thrust is generated in the circumferential direction around the axis X passing through the gravity center position G by rotating each of the thrust vectoring units 24 by the same angle in the same direction. That is, thrust is generated from one side toward the other side in the circumferential direction at each outlet-side opening 26 of the manifold 25. In this way, a moment from one side to the other side in the circumferential direction around the yaw axis is generated in the entire electric flight vehicle 1, and a yawing motion is performed. The movement and the posture of the electric flight vehicle 1 are controlled by appropriately combining the horizontal movement and the yawing motion as described above.

### (Method for Controlling Electric Flight Vehicle)

Subsequently, a control flow at the time of take-off/landing of the electric flight vehicle 1 will be described with reference to FIG. 8. As shown in FIG. 8, in this control flow, the central propulsor 20a is first started in step S11. The central propulsor 20a is controlled such that the rotation speed increases until a rated rotation speed determined in advance is reached. In this way, the direction of the airflow that has reached the thrust vectoring unit 24 through the manifold 25 can be freely controlled. That is, a state where a rudder is effective is created. Thereafter, in step S12, all of the plurality of peripheral propulsors 20b are driven. By driving the peripheral propulsors 20b, ascending thrust is given to the airframe 10, and the airframe 10 takes off. Thereafter, when the electric flight vehicle arrives at the destination, step S13 is executed for landing. In step S13, the rotation speed of the peripheral propulsor 20b is decreased to reduce the ascending thrust. In this way, the airframe 10 descends. In this state, the rotation speed of the central propulsor 20a is maintained at the rated rotation speed. Thereafter, when the airframe 10 has landed, the central propulsor 20a is stopped in step S14. By the above, the control flow relating to the take-off/landing of the electric flight vehicle 1 is ended.

### (Operation and Effect)

Here, in the electric flight vehicle 1 of the related art, a method for controlling the movement direction D of the airframe 10 only by controlling the rotation speed of the propulsor 20 has been general. For example, when the airframe 10 moves in the horizontal direction, the airframe 10 is tilted by increasing the rotation speed of the propulsor 20 on a side opposite to the direction in which the airframe 10 is to move. In this way, it has been considered that the thrust direction is changed and the airframe 10 can move in a desired direction. However, in a case where the posture of the airframe 10 is controlled only by controlling the rotation speed as described above, it takes time to tilt the airframe 10, and there is a possibility that the posture may be disrupted due to an external force such as a gust of wind during that time. Therefore, there has been an increasing demand for a technique for moving the airframe 10 without tilting the airframe 10. In particular, there has been a demand for a technique that enables precise posture control at the time of take-off/landing. Therefore, the electric flight vehicle 1 according to the present embodiment adopts the method and each configuration described above.

According to the above method, the central propulsor 20a is first started before take-off, so that the thrust vectoring of the airflow by the thrust vectoring unit 24 becomes possible from a time point before take-off. The airframe 10 takes off by driving the peripheral propulsors 20b from this state. At this time point, the direction of the airflow jetted from the central propulsor 20a can be controlled by the thrust vectoring unit 24. In this way, the posture of the airframe 10 can be stabilized immediately after take-off. Therefore, even in a case where gust of wind or the like is received at the time of take-off and a change occurs in the posture of the airframe 10, the change can be immediately corrected and the normal posture can be restored. In this way, the electric flight vehicle 1 can be stably operated.

In addition, according to the above method, the airframe 10 descends by reducing the rotation speed of the peripheral propulsor 20b prior to landing. In this state, the central propulsor 20a is operated at the rated rotation speed. Therefore, the direction of the airflow jetted from the central propulsor 20a can be controlled by the thrust vectoring unit 24. Thereafter, the central propulsor 20a is stopped when the airframe 10 has landed. In this way, the posture of the airframe 10 can be stabilized by the operation of the thrust vectoring unit 24 in all phases of the landing operation. Therefore, even in a case where gust of wind or the like is received during landing and a change occurs in the posture of the airframe 10, the change can be immediately corrected and the normal posture can be restored. In this way, the electric flight vehicle 1 can be operated more stably.

In addition, according to the above-described configuration, the thrust direction of the central propulsor 20a can be freely adjusted by changing the direction of the airflow flowing out from the manifold 25 by the thrust vectoring unit 24. In this way, the horizontal movement or the position adjustment can be performed without greatly changing the posture of the electric flight vehicle 1. Therefore, it is possible to stably and smoothly transport an article to the destination without breaking the weight balance of the article or the like loaded on the airframe 10. Furthermore, since time is not required for tilting the airframe 10 immediately before the movement, the possibility of being affected by a gust of wind or the like during the time can be reduced. Therefore, it is possible to realize a more stable operation of the electric flight vehicle 1. In addition, the rotation operation of the electric flight vehicle 1 around the yaw axis can also be realized by making the direction of the airflow by the thrust vectoring unit 24 coincide with the direction from one side to the other side in the circumferential direction around the center of gravity. In this manner, it is possible to easily perform minute movement, position adjustment, and yawing.

Further, according to the above-described configuration, the direction of the airflow flowing from the duct 23 can be changed only by changing the rotation angle of the flap 24a serving as the thrust vectoring unit 24. In this way, it is possible to easily perform minute movement, position adjustment, and yawing with a simple configuration. In addition, since the thrust direction is immediately changed when the rotation angle of the thrust vectoring unit 24 is changed, the responsiveness of the electric flight vehicle 1 to the piloting operation can also be improved.

In addition, according to the above-described configuration, first, the control unit 30 operates the thrust vectoring unit 24 to generate the thrust directed to the rear side in the movement direction D. At that time, the pitching moment M with the horizontal direction as an axis occurs in the airframe 10. Therefore, the rotation speed control unit 33 makes the rotation speed of the electric motor 21 of the peripheral propulsor 20b located on the front side in the movement direction D higher than the rotation speed of the electric motor 21 of the peripheral propulsor 20b located on the rear side. In this way, the counter-moment M′ in the opposite direction is generated, and the pitching moment M is canceled out. Therefore, the airframe 10 can be moved in the movement direction D without being tilted. In this way, the airframe 10 can smoothly move without being affected by the weight balance of cargo or an external force due to a gust of wind. In particular, it is advantageous when transporting delicate articles that are damaged when tilted or long articles that are difficult to balance in weight.

In addition, according to the above-described configuration, the thrust vectoring unit 24 generates the thrust around the yaw axis, so that the airframe 10 can be rotated on the spot. In addition, conversely, when the airframe 10 is unintentionally rotated by an external force such as wind, the airframe 10 can be immediately restored to the initial posture by performing the above operation. In this way, the precision and accuracy of the posture control of the electric flight vehicle 1 are improved, and the electric flight vehicle 1 can be used for various purposes, in addition to movement and transport. That is, the versatility of the electric flight vehicle 1 can be greatly improved.

In addition, since the thrust vectoring units 24 are disposed to be centralized at the outlet-side opening 26 of the manifold 25, the number of movable portions can be reduced as compared to a configuration in which the thrust vectoring units 24 are provided in the ducts 23 of the respective propulsors 20, for example. In this way, the number of components can be reduced, and maintenance costs and manufacturing costs can be significantly reduced.

The first embodiment of the present disclosure has been described above. Various changes and modifications can be made to the above configuration within a scope which does not depart from the gist of the present disclosure.

### Second Embodiment

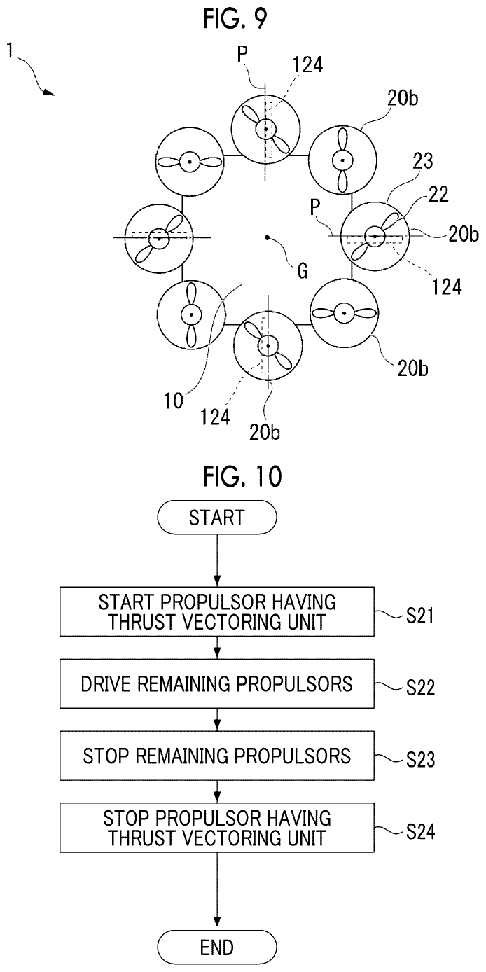

Next, a second embodiment of the present disclosure will be described with reference to FIGS. 9 and 10. The same configurations as those in the first embodiment described above are denoted by the same reference numerals, and detailed description thereof is omitted.

As shown in FIG. 9, the electric flight vehicle 1 according to the present embodiment does not include the central propulsor 20a described in the first embodiment, and only the peripheral propulsor 20b is provided in the airframe 10. Eight peripheral propulsors 20b are provided to surround the gravity center position G of the airframe 10 in a plan view. Specifically, one peripheral propulsor 20b is provided at each corner of the airframe 10 having a rectangular shape, one peripheral propulsor 20b is provided at each side, and thus a total of eight peripheral propulsors 20b are provided. A duct thrust vectoring unit 124 similar to the thrust vectoring unit 24 described above is provided in a part of the peripheral propulsors 20b, that is, in the peripheral propulsor 20b provided at each side portion. The duct thrust vectoring unit 124 is attached to the duct 23 of the peripheral propulsor 20b, and is rotatable around a rotation axis P extending in the radial direction with respect to the axis X. The four duct thrust vectoring units 124 extend in four different directions in an in-plane direction orthogonal to the center of gravity of the airframe 10. The operation of the four duct thrust vectoring units 124 and the control flow of the control unit 30 are the same as those described in the first embodiment.

### (Method for Controlling Electric Flight Vehicle)

Next, a control flow at the time of take-off/landing of the electric flight vehicle 1 will be described with reference to FIG. 10. As shown in FIG. 10, in this control flow, in Step S21, the peripheral propulsor 20b having the duct thrust vectoring unit 124 is first started. The peripheral propulsor 20b is controlled such that the rotation speed is increased until a rated rotation speed determined in advance is reached. In this way, the direction of the airflow reaching the duct thrust vectoring unit 124 can be freely controlled. That is, a state where a rudder is effective is created. Thereafter, in step S22, all of the remaining peripheral propulsors 20b are driven. By driving the peripheral propulsors 20b, ascending thrust is given to the airframe 10, and the airframe 10 takes off. Thereafter, when the electric flight vehicle arrives at the destination, step S23 is executed for landing. In step S23, the rotation speed of the peripheral propulsor 20b that does not have the duct thrust vectoring unit 124 is decreased to reduce the ascending thrust. In this way, the airframe 10 descends. In this state, the rotation speed of the peripheral propulsor 20b having the duct thrust vectoring unit 124 is maintained at the rated rotation speed. Thereafter, when the airframe 10 has landed, all the peripheral propulsors 20b are stopped in step S24. By the above, the control flow relating to the take-off/landing of the electric flight vehicle 1 is ended.

### (Operation and Effect)

According to the above method, the peripheral propulsor 20b having the duct thrust vectoring unit 124 is first started before take-off, so that the thrust vectoring of the airflow by the duct thrust vectoring unit 124 becomes possible from a time point before take-off. The airframe 10 takes off by driving the remaining peripheral propulsors 20b from this state. At this time point, the direction of the airflow jetted from the peripheral propulsor 20b having the duct thrust vectoring unit 124 can be controlled by the duct thrust vectoring unit 124. In this way, the posture of the airframe 10 can be stabilized immediately after take-off. Therefore, even in a case where gust of wind or the like is received at the time of take-off and a change occurs in the posture of the airframe 10, the change can be immediately corrected and the normal posture can be restored. In this way, the electric flight vehicle 1 can be operated more stably.

Further, according to the above method, the airframe 10 descends by reducing the rotation speed of the peripheral propulsor 20b that does not have the duct thrust vectoring unit 124 prior to landing. In this state, the propulsor 20b having the duct thrust vectoring unit 124 is operated at the rated rotation speed. Therefore, the direction of the airflow jetted from the peripheral propulsor 20b can be controlled by the duct thrust vectoring unit 124. Thereafter, when the airframe 10 has landed, the peripheral propulsors 20b are stopped. In this way, the posture of the airframe 10 can be stabilized by the operation of the duct thrust vectoring unit 124 in all phases of the landing operation. Therefore, even in a case where gust of wind or the like is received during landing and a change occurs in the posture of the airframe 10, the change can be immediately corrected and the normal posture can be restored. In this way, the electric flight vehicle 1 can be operated more stably.

In addition, according to the above-described configuration, the thrust direction of the peripheral propulsor 20b can be freely adjusted by changing the direction of the airflow that has passed through the duct 23 of the peripheral propulsor 20b by the duct thrust vectoring unit 124. In this way, the horizontal movement or the position adjustment can be performed without greatly changing the posture of the electric flight vehicle 1. Therefore, it is possible to stably and smoothly transport an article to the destination without breaking the weight balance of the article or the like loaded on the airframe 10. Furthermore, since time is not required for tilting the airframe 10 immediately before the movement, the possibility of being affected by a gust of wind or the like during the time can be reduced. Therefore, it is possible to realize a more stable operation of the electric flight vehicle 1. In addition, the rotation operation of the electric flight vehicle 1 around the yaw axis can also be realized by making the direction of the airflow by the duct thrust vectoring unit 124 coincide with the direction from one side to the other side in the circumferential direction around the center of gravity. In this manner, it is possible to easily perform minute movement, position adjustment, and yawing.

The second embodiment of the present disclosure has been described above. Various changes and modifications can be made to the above configuration within a scope which does not depart from the gist of the present disclosure.

### Other Embodiments

Although the embodiments of the present disclosure have been described in detail above with reference to the drawings, the specific configurations of the present disclosure are not limited to the embodiments, and the present disclosure includes design changes or the like within a scope which does not depart from the gist of the present disclosure.

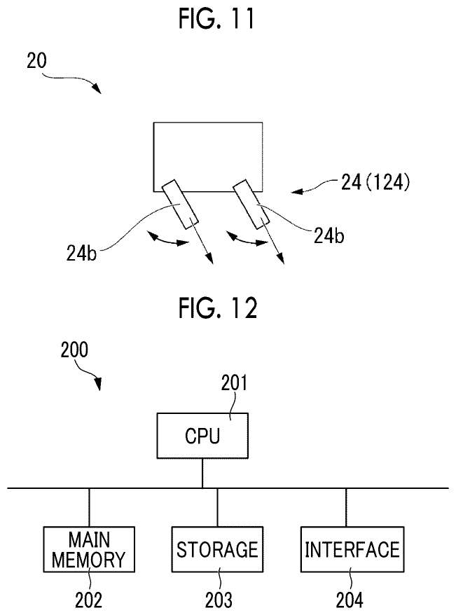

For example, it is also possible to adopt the configuration shown in FIG. 11 as a modification example of the thrust vectoring unit 24 and the duct thrust vectoring unit 124. In the example of FIG. 11, the thrust vectoring unit 24 has a nozzle 24b which extends from the duct 23 toward the downstream side of the airflow and in which a direction of the outlet can be freely changed. The nozzle 24b has a tubular shape, and a flow path through which an airflow flows is formed inside the nozzle 24b. With this configuration as well, the same operation and effects as those described above can be obtained. In addition, the nozzle 24b may be formed of a material that is elastically deformable. Also in this case, the direction in which an outlet-side end portion extends can be changed by an actuator, so that an airflow in a desired direction can be generated.

Further, the shape of the airframe 10 described in the above embodiments is an example, and any shape or dimension and physical size appropriately selected according to design and specifications can be adopted. Even though the shape or the dimension and physical size of the airframe 10 changes, the configuration and the control flow described in the above embodiment can be applied. In addition, the number of the propulsors 20 may be appropriately determined according to the shape, the dimension and physical size, the weight, or the like of the airframe 10.

In addition, the configuration of the propulsor 20 itself described in the above embodiments is also an example, and a configuration in which a stator vane is further provided on the downstream side of the fan 22 can be adopted. The stator vane is provided to straighten the flow of air pumped by the fan 22. With this configuration as well, the same operation and effects as those described above can be obtained.

Further, in the control unit 30, it is desirable that the generation of the drive signal by the drive signal generation unit 32 and the control of the rotation speed by the rotation speed control unit 33 are autonomously performed after the movement direction signal reception unit 31 receives the input of the movement direction D. In other words, it is desirable that the user inputs only the movement direction D and the subsequent processing is autonomously performed by the control unit 30. Similarly, a configuration may be made such that after receiving the input of the movement direction D, the yawing is automatically performed by the drive signal generation unit 32 and the rotation speed control unit 33.

The airframe 10 described above may be capable of accommodating personnel. In that case, it is desirable that the airframe 10 is equipped with a flight control device and a navigation device.

In addition, the rotation speed of the thrust vectoring unit 24 may be changed based on the input of an acceleration in the movement direction D. In this way, the airframe 10 can be precisely controlled in accordance with the input acceleration in the movement direction D.

In a processing flow of the control unit 30 of the embodiments of the present disclosure, the order of processing may be changed in a range in which appropriate processing is performed.

Each of the storage unit 34 and other storage devices in the embodiments of the present disclosure may be provided anywhere in a range in which appropriate information is transmitted and received. Further, each of the storage unit 34 and the other storage devices may be present in a plurality in a range in which appropriate information is transmitted and received, and data may be stored in a distributed manner.

The process of the processing by the control unit 30 described above is stored in the form of a program in a recording medium that can be read by a computer 200, and the computer 200 reads out and executes this program, so that the processing is performed. A specific example of the computer 200 will be described below.

As shown in FIG. 12, the computer 200 includes a CPU 201, a main memory 202, a storage 203, and an interface 204.

For example, the control unit 30 described above is mounted on the computer 200. Then, the operation of each processing unit described above is stored in the storage 203 in the form of a program. The CPU 201 reads the program from the storage 203, develops the program in the main memory 202, and executes the above processing according to the program. Further, the CPU 201 secures a storage area corresponding to the storage unit 34 described above in the main memory 202 according to the program.

As examples of the storage 203, a hard disk drive (HDD), a solid-state drive (SSD), a magnetic disk, a magneto-optical disk, a compact disc read-only memory (CD-ROM), a digital versatile disc read-only memory (DVD-ROM), a semiconductor memory, and the like can be given. The storage 203 may be an internal medium directly connected to a bus of the computer 200 or may be an external medium that is connected to the computer 200 via the interface 204 or a communication line. Further, in a case where this program is distributed to the computer 200 via a communication line, the computer 200 receiving the distribution may develop the program in the main memory 202 and execute the above processing. The storage 203 is a non-temporary tangible storage medium.

In addition, the program may realize some of the functions described above. Furthermore, the program may be a so-called differential file (differential program) that can realize the above-described functions in combination with a program already recorded in the computer 200.

A custom large scale integrated circuit (LSI) such as a programmable logic device (PLD), an application specific integrated circuit (ASIC), a graphics processing unit (GPU), and a processing device similar thereto may be provided in addition to the above-described configuration or instead of the above-described configuration. As examples of the PLD, a programmable array logic (PAL), a generic array logic (GAL), a complex programmable logic device (CPLD), and a field programmable gate array (FPGA) can be given. In this case, a part or all of the functions that are realized by the processor may be realized by the integrated circuit.

### Additional Remark

The method for controlling the electric flight vehicle 1 described in each embodiment is understood as follows, for example.

(1) A method for controlling an electric flight vehicle 1 according to a first aspect is a method for controlling an electric flight vehicle 1 that includes an airframe 10, a central propulsor 20a that is disposed in a region including a gravity center position G of the airframe 10 in a plan view and that has an electric motor 21, a fan 22 that is rotationally driven by the electric motor 21, and a tubular duct 23 that covers the fan 22 from an outer periphery side, a manifold 25 that is connected to an outlet of the central propulsor 20a and that extends in a plurality of different directions to divert an airflow in the plurality of directions, a thrust vectoring unit 24 that is provided at each outlet of the manifold 25 and that thrust-vectors the airflow, a thrust vectoring actuator unit that controls an angle of the thrust vectoring unit 24, and a plurality of peripheral propulsors 20b that are provided in the airframe 10 to surround the central propulsor 20a from an outer periphery side in a plan view, and each of which has an electric motor 21, a fan 22 that is rotationally driven by the electric motor 21, and a tubular duct 23 that covers the fan 22 from the outer periphery side, the method comprising: a step S11 of starting the central propulsor 20a until a rated rotation speed is reached; and a step S12 of causing the airframe 10 to take off by driving the plurality of peripheral propulsors 20b after the central propulsor 20a has reached the rated rotation speed.

According to the above method, the central propulsor 20a is first started before take-off, so that the thrust vectoring of the airflow by the thrust vectoring unit 24 becomes possible from a time point before take-off. The airframe 10 takes off by driving the peripheral propulsors 20b from this state. At this time point, the direction of the airflow jetted from the central propulsor 20a can be controlled by the thrust vectoring unit 24. In this way, the posture of the airframe 10 can be stabilized immediately after take-off.

(2) In a method for controlling an electric flight vehicle 1 according to a second aspect, the method for controlling an electric flight vehicle 1 according to the above (1) further includes: a step S13 of reducing a rotation speed of the peripheral propulsor 20b; and a step S14 of landing the airframe 10 by reducing a rotation speed of the central propulsor 20a after the rotation speed of the peripheral propulsor 20b has been reduced.

According to the above method, the airframe 10 descends by reducing the rotation speed of the peripheral propulsor 20b prior to landing. In this state, the central propulsor 20a is operated at the rated rotation speed. Therefore, the direction of the airflow jetted from the central propulsor 20a can be controlled by the thrust vectoring unit 24. Thereafter, the central propulsor 20a is stopped when the airframe 10 has landed. In this way, the posture of the airframe 10 can be stabilized by the operation of the thrust vectoring unit 24 in all phases of the landing operation.

(3) A method for controlling an electric flight vehicle 1 according to a third aspect is a method for controlling an electric flight vehicle 1 that includes an airframe 10, a plurality of peripheral propulsors 20b that are provided in the airframe 10 to surround a gravity center position G of the airframe 10 from an outer periphery side in a plan view, and each of which has an electric motor 21, a fan 22 that is rotationally driven by the electric motor 21, and a tubular duct 23 that covers the fan 22 from the outer periphery side, and a duct thrust vectoring unit 124 that is provided in a part of the plurality of peripheral propulsors 20b to thrust-vector an airflow from the duct 23, the method comprising: a step S21 of starting the peripheral propulsor 20b having the duct thrust vectoring unit 124 until a rated rotation speed is reached; and a step S22 of causing the airframe 10 to take off by driving remaining peripheral propulsors 20b after the peripheral propulsor 20b having the duct thrust vectoring unit 124 has reached the rated rotation speed.

According to the above method, the peripheral propulsor 20b having the duct thrust vectoring unit 124 is first started before take-off, so that the thrust vectoring of the airflow by the duct thrust vectoring unit 124 becomes possible from a time point before take-off. The airframe 10 takes off by driving the remaining peripheral propulsors 20b from this state. At this time point, the direction of the airflow jetted from the peripheral propulsor 20b having the duct thrust vectoring unit 124 can be controlled by the duct thrust vectoring unit 124. In this way, the posture of the airframe 10 can be stabilized immediately after take-off.

(4) In A method for controlling an electric flight vehicle 1 according to a fourth aspect, the method for controlling an electric flight vehicle 1 according to the above (3) further includes: a step S23 of reducing rotation speeds of the remaining peripheral propulsors 20b; and a step S24 of landing the airframe 10 by reducing the rotation speed of the peripheral propulsor 20b having the duct thrust vectoring unit 124 after the rotation speeds of the remaining peripheral propulsors 20b have been reduced.

According to the above method, the airframe 10 descends by reducing the rotation speed of the peripheral propulsor 20b that does not have the duct thrust vectoring unit 124 prior to landing. In this state, the propulsor 20b having the duct thrust vectoring unit 124 is operated at the rated rotation speed. Therefore, the direction of the airflow jetted from the peripheral propulsor 20b can be controlled by the duct thrust vectoring unit 124. Thereafter, when the airframe 10 has landed, the peripheral propulsors 20b are stopped. In this way, the posture of the airframe 10 can be stabilized by the operation of the duct thrust vectoring unit 124 in all phases of the landing operation.

### INDUSTRIAL APPLICABILITY

According to the present disclosure, it is possible to provide an electric flight vehicle capable of moving without disrupting the posture of an airframe.

### REFERENCE SIGNS LIST

1: electric flight vehicle
10: airframe
20: propulsor
20a: central propulsor
20b: peripheral propulsor
21: electric motor
22: fan
23: duct
24: thrust vectoring unit
24a: flap
24b: nozzle
25: manifold
26: outlet-side opening
30: control unit
31: movement direction signal reception unit
32: drive signal generation unit
33: rotation speed control unit
34: storage unit
41: electric motor main body
42: output shaft
51: spinner
52: blade
120: horizontal propulsor
124: duct thrust vectoring unit
200: computer
201: CPU
202: main memory
203: storage
204: interface
D: movement direction
G: gravity center position
M: pitching moment
M′: counter-moment
O: central axis
P: rotation axis
Q: tilt axis
X: axis
Y: rotation axis

1. A method for controlling an electric flight vehicle that includes
an airframe,
a central propulsor that is disposed in a region including a gravity center position of the airframe in a plan view and that has an electric motor, a fan that is rotationally driven by the electric motor, and a tubular duct that covers the fan from an outer periphery side,
a manifold that is connected to an outlet of the central propulsor and that extends in a plurality of different directions to divert an airflow in the plurality of directions,
a thrust vectoring unit that is provided at each outlet of the manifold and that thrust-vectors the airflow,
a thrust vectoring actuator unit that controls an angle of the thrust vectoring unit, and
a plurality of peripheral propulsors that are provided in the airframe to surround the central propulsor from an outer periphery side in a plan view, and each of which has an electric motor, a fan that is rotationally driven by the electric motor, and a tubular duct that covers the fan from the outer periphery side,
the method comprising:
a step of starting the central propulsor until a rated rotation speed is reached; and
a step of causing the airframe to take off by driving the plurality of peripheral propulsors after the central propulsor has reached the rated rotation speed.

2. The method for controlling an electric flight vehicle according to claim 1, further comprising:
a step of reducing a rotation speed of the peripheral propulsor; and
a step of landing the airframe by reducing a rotation speed of the central propulsor after the rotation speed of the peripheral propulsor has been reduced.

3. A method for controlling an electric flight vehicle that includes
an airframe,
a plurality of peripheral propulsors that are provided in the airframe to surround a gravity center position of the airframe from an outer periphery side in a plan view, and each of which has an electric motor, a fan that is rotationally driven by the electric motor, and a tubular duct that covers the fan from the outer periphery side, and
a duct thrust vectoring unit that is provided in a part of the plurality of peripheral propulsors to thrust-vector an airflow from the duct and is rotatable,
the method comprising:
a step of starting the peripheral propulsor having the duct thrust vectoring unit until a rated rotation speed is reached; and
a step of causing the airframe to take off by driving remaining peripheral propulsors after the peripheral propulsor having the duct thrust vectoring unit has reached the rated rotation speed.

4. The method for controlling an electric flight vehicle according to claim 3, further comprising:
a step of reducing rotation speeds of the remaining peripheral propulsors; and
a step of landing the airframe by reducing the rotation speed of the peripheral propulsor having the duct thrust vectoring unit after the rotation speeds of the remaining peripheral propulsors have been reduced.
